(19) United States
(12) Patent Application Publication
(10) Pub. No.: US 2020/0249523 A1
(43) Pub. Date: Aug. 6, 2020

(54) COLOR FILTER SUBSTRATE

(71) Applicant: WUHAN CHINA STAR OPTOELECTRONICS TECHNOLOGY CO., LTD., Wuhan (CN)

(72) Inventors: Fang GONG, Wuhan (CN); Heng ZHANG, Wuhan (CN); Bangrong LI, Wuhan (CN)

(73) Assignee: WUHAN CHINA STAR OPTOELECTRONICS TECHNOLOGY CO., LTD., Wuhan (CN)

(21) Appl. No.: 16/475,140

(22) PCT Filed: Mar. 22, 2019
(86) PCT No.: PCT/CN2019/079158

§ 371 Date: Jul. 1, 2019

(30) Foreign Application Priority Data
Dec. 27, 2018 (CN) 201911615681.7

(51) Int. Cl. G02F 1/1335; G02B 5/20

(52) U.S. Cl. CPC G02F 1/133514; G02F 1/133512; G02B 5/201

(57) ABSTRACT

A color filter substrate includes a display area and a non-display area, in a pixel arrangement direction. The display area includes a first region in contact with the non-display area, and a second region not in contact with the non-display area. Opening ratios of pixels in the first region are smaller than opening ratios of pixels in the second region, such that the pixels in the region in the display area that is in contact with the non-display area and the pixels in the region in the display area that is not in contact with the non-display area have the same color mixing effects.

### FIELD OF INVENTION

This invention relates to the field of display technologies and particularly to a color filter substrate.

### BACKGROUND OF INVENTION

The color filter substrate includes a display area and a frame area surrounding the display area, when the screen is displayed, the lights of the adjacent pixels in the display area are mixed to achieve the display effect.

However, beside the pixels in the display area close to the frame area is a black matrix, and when the lights are mixed, the light of one pixel close to the frame area can only be mixed with light of another pixel and the pure black, and light of one pixel in the display area not close to the frame area is mixed with lights of two pixels. Thus, pixels in different positions of the display area will display different color mixing effects.

Therefore, the conventional color filter substrate has a technical problem that pixels in a region in the display area that is in contact with the non-display area and pixels in a region in the display area that is not in contact with the non-display area have different color mixing effects.

### SUMMARY OF INVENTION

In order to solve the above problems, the technical solution provided by the present invention is described as follows:

A color filter substrate, includes:

a non-display area;

a display area, in a pixel arrangement direction, includes a first region in contact with the non-display area, and a second region not in contact with the non-display area. Opening ratios of pixels in the first region are smaller than opening ratios of pixels in the second region.

The display area further includes a third region between the first region and the second region. Opening ratios of pixels in the third region are greater than the opening ratios of the pixels in the first region, and the opening ratios of the pixels in the third region are smaller than the opening ratios of the pixels in the second region.

The first region includes a column of pixels.

According to the color filter substrate provided by the present invention, the opening ratio of each pixel in the first region is smaller than the opening ratio of each pixel in the second region.

According to the color filter substrate provided by the present invention, the opening ratios of columns of sub-pixels of the pixels in the first region are the same.

According to the color filter substrate provided by the present invention, the opening ratios of rows of sub-pixels of the pixels in the first region are the same.

According to the color filter substrate provided by the present invention, in the first region the average value of the opening ratios of columns of sub-pixels of the pixels is equal to the average value of the opening ratios of rows of sub-pixels of the pixels.

The present invention provides a color filter substrate, includes:

a non-display area; and

a display area, in a pixel arrangement direction, includes a first region in contact with the non-display area, and a second region not in contact with the non-display area, and opening ratios of pixels in the first region are smaller than opening ratios of pixels in the second region.

According to the color filter substrate provided by the present invention, the first region includes a left side region in contact with the non-display area and a right side region in contact with the non-display area.

According to the color filter substrate provided by the present invention, the opening ratios of pixels in the left side region are equal to the opening ratios of pixels in the right side region.

According to the color filter substrate provided by the present invention, the first region includes a column of pixels.

According to the color filter substrate provided by the present invention, the opening ratio of each pixel in the first region is smaller than the opening ratio of each pixel in the second region.

According to the color filter substrate provided by the present invention, the opening ratios of columns of sub-pixels of the pixels in the first region are the same.

According to the color filter substrate provided by the present invention, the opening ratios of rows of sub-pixels of the pixels in the first region are the same.

According to the color filter substrate provided by the present invention, in the first region the average value of the opening ratios of columns of sub-pixels of the pixels is equal to the average value of the opening ratios of rows of sub-pixels of the pixels.

According to the color filter substrate provided by the present invention, the ratio of the opening ratio of the pixels in the first region to the opening ratio of the pixels in the second region is 0.6.

The color filter substrate provided by the present invention, further includes a third region between the first region and the second region. Opening ratios of pixels in the third region are greater than the opening ratios of the pixels in the first region, and the opening ratios of the pixels in the third region are smaller than the opening ratios of the pixels in the second region.

According to the color filter substrate provided by the present invention, the third region includes a column of pixels.

According to the color filter substrate provided by the present invention, the opening ratio of each pixel in the third region is greater than the opening ratio of each pixel in the first region, and the opening ratio of each pixel in the third region is smaller than the opening ratio of each pixel in the second region.

According to the color filter substrate provided by the present invention, the opening ratios of columns of sub-pixels of the pixels in the third region are the same.

According to the color filter substrate provided by the present invention, the opening ratios of rows of sub-pixels of the pixels in the third region are the same.

According to the color filter substrate provided by the present invention, in the third region the average value of the opening ratios of columns of sub-pixels of the pixels is equal to the average value of the opening ratios of rows of sub-pixels of the pixels.

### DESCRIPTION OF DRAWINGS

In order to more clearly illustrate the embodiments of the invention or the technical solutions in the prior art, the drawings used in the embodiments or the prior art will be briefly described below. Obviously, the drawings in the following description are only for some embodiments of the invention, and other drawings may be obtained from those skilled in the art without any creative work.

FIG. 1 is a structural schematic view of a conventional color filter substrate.

FIG. 2 is a structural schematic view of a color filter substrate according to an embodiment of the present invention.

### DETAILED DESCRIPTION OF PREFERRED EMBODIMENTS

The following description of the various embodiments is provided to illustrate the specific embodiments Directional terms mentioned in this invention, such as [upper], [lower], [front], [back], [left], [right], [inside], [outside], [side], etc., are only the direction of the drawing for reference. Therefore, the directional terminology used is for the purpose of illustration and understanding, and is not intended to be limited. In the figure, structurally similar elements are denoted by the same reference numerals.

The present invention is directed to the technical problem that the conventional color filter substrate has different color mixing effects in different positions of the display area, and the embodiment of the present invention can solve the problem.

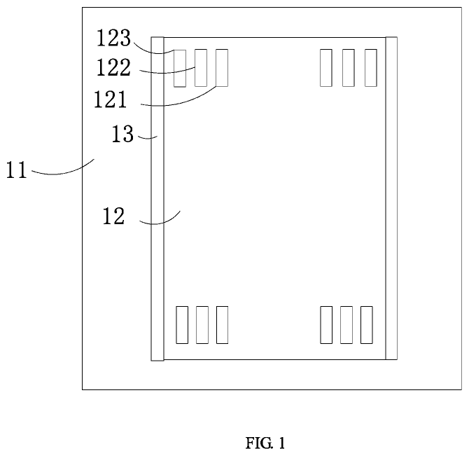

As shown in FIG. 1, the conventional color filter substrate includes a non-display area 11 and a display area 12, and pixels are arranged in an array of red sub-pixels 123, green sub-pixels 122, and blue sub-pixels 121 in the display area 12, every three sub-pixels make up one pixel. Some red sub-pixels 123 and some blue sub-pixels 121 are respectively disposed on both sides of the most edge of the display area 12, and a black matrix 13 adjacent to the display area 12 is disposed in the non-display area 11.

When a conventional liquid crystal display (LCD) displays a pure red picture, the pixels in the middle portion are mixed with the adjacent pixels, and beside the most edged pixels is a black matrix, and the most edge pixels are mixed with the adjacent pixels and the black matrix to make the edge of the display area yellowish. When the pure blue picture is displayed, the same as the display of the pure red picture, the display area edge will be whitish. While the gray scale picture is displayed, the middle area shows white, the most edged pixel is mixed with the black matrix on one side, and the red and blue lines will be displayed at the edge of the display area.

In summary, the conventional color filter substrate has a technical problem that the pixels in the region in the display area that are in contact with the non-display area and the pixels in the region in the display area that is not in contact with the non-display area have different color mixing effects. In response to this problem, the present invention proposes the following embodiments.

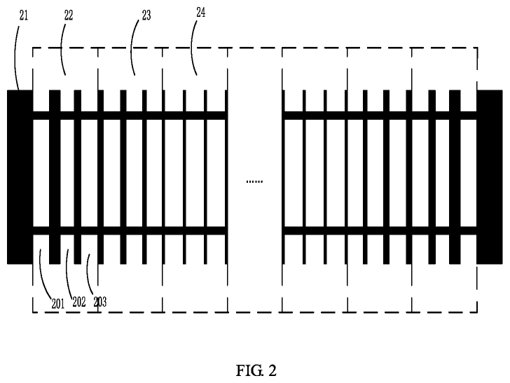

In the embodiment of the present invention, the opening ratio is a ratio of the opening area to the total area in the display area. For example, the opening ratios of pixels in the second region in FIG. 2 are the opening areas of the pixels in the second region to the total area in the display area. Other opening ratios are defined as the opening ratios of the pixels in the second region, and will not be repeated in the following embodiments.

As shown in FIG. 2, the embodiment of the present invention provides a color filter substrate, which includes a display area and a non-display area. In the arrangement direction of the pixels, the display area includes a first region 22 in contact with the non-display area, and a second region 24 not in contact with the non-display area. A black matrix 21 is disposed in the non-display area and adjacent to the display area, and the black matrix 21 is disposed between the pixels. The opening ratios of the pixels in the first region are smaller than the opening ratios of the pixels in the second region.

In the embodiment of the present invention, in the case that the total area in the display area is kept unchanged, by increasing the area of the black matrix in the display area, the opening ratios of the pixels in the first region are reduced, such that the area displayed after the light of the pixels in the first region mixed with the pure black of the black matrix is reduced, so that different regions in the display area exhibit approximately the same or even the same color mixing effect, which alleviates the technical problems of the conventional color filter substrate that the pixels in the region in the display area that are in contact with the non-display area and the pixels in the region in the display area that is not in contact with the non-display area have different color mixing effects.

As shown in FIG. 2, in the embodiment of the present invention, the first region includes a left side region in contact with the non-display area, and a right side region in contact with the non-display area. By reducing the opening ratios of the pixels on both sides of the display area, the color filter substrate can display approximately the same or even the same color mixing effect in different regions of the display area when displaying a pure red picture or a pure blue picture. In order to make the same color mixing effect appear in different positions of the display area, the present invention provides the following embodiments.

Referring to FIG. 2, the embodiment of the present invention provides a color filter substrate. A third region 23 is disposed between the first region 22 and the second region 24. By controlling the black matrix 21, the opening ratios of the pixels in the third region are greater than the opening ratios of the pixels in the first region, and the opening ratios of the pixels in the third region are smaller than the opening ratios of the pixels in the second region. By setting the third region between the first region and the second region, and controlling the opening ratios of the pixels in the third region to be between the opening ratios of the pixels in the first region and the opening ratios of the pixels in the second region, the third region takes buffering effects for color mixing, so that different areas of the display area exhibit the same color mixing effect.

In the embodiment of the present invention, the first region may include a column of pixels or a plurality of columns of pixels, and the third region may include a column of pixels or a plurality of columns of pixels. The opening ratios of the plurality of columns are increased along a direction away from the non-display area and take different buffering effects, so that the different regions of the display area appear more similar or even the same color mixing effect.

In the embodiment of the present invention, the opening ratios of different columns of sub-pixels in each column of pixels may be increased, and this may cause a problem of uneven display of brightness when detecting two or more columns of pixels. For this problem, the present invention provides the following embodiment.

As shown in FIG. 2, the embodiment of the present invention divides the pixels into an array of red sub-pixels 201, green sub-pixels 202, and blue sub-pixels 203. By controlling the area of the black matrix 21, the opening ratio of each sub-pixel is randomly reduced, but the opening ratio of each column of sub-pixels in each column of pixels is controlled to be the same, and the sum of the opening areas of each row of sub-pixels is the same, so that when two or more columns of pixels are used for image detection, the pixels emit light with uniform brightness.

In the embodiment of the present invention, all opening ratios of all sub-pixels of the pixels in the first region are set to be smaller than the corresponding opening ratios of sub-pixels of the pixels in the third region, and all opening ratios of all sub-pixels of the pixels in the third region are set to be smaller than the corresponding opening ratios of the sub-pixels of the pixels in the second region, such that to the same kind of the sub-pixels, the opening ratios of the sub-pixels are increased in a direction away from the non-display area, so that the area of the color mixed by the lights of the sub-pixels and the pure black of the black matrix can be reduced, and the area of the mixed color display is increased accordingly, thereby displaying more similar or even the same color mixing effect in different regions of the display area.

In one embodiment, the opening ratios of the rows of pixels in the first region are the same, that is, for each row the sum of opening ratio of the red sub-pixel, the opening ratio of the blue sub-pixel and the opening ratio of the green sub-pixel is equal, but not limited to the opening ratio of each sub-pixel, so that the opening ratio of each sub-pixel is randomly set.

In the embodiment of the present invention, the opening area of pixel cannot be too small, and when the buffer area is formed, the color mixing effects exhibited in the different positions of the display area are more similar. Let the opening ratio of the pixel in the second region is s, the opening ratio of the pixel in the first region is ns, and further defines that the opening ratio of the pixel in the third region is (n+1) s/2, when n is defined as 0.6 to 0.8, the color mixing effects in different regions of the display area are more similar or even the same.

The embodiment of the present invention provides a liquid crystal display device, which includes an array substrate, a color filter substrate provided by the embodiment of the present invention, and a liquid crystal layer disposed between the two substrates. A thin film transistor array is disposed on the array substrate, and the array substrate is used for rotating the liquid crystal and controlling the pixel display. The color filter substrate is used to adjust the color of the pixels to display different pictures. By setting the opening ratio of the pixels in the first region of the color filter substrate to be smaller than the opening ratio of the pixels in the second region of the color filter substrate, when the liquid crystal display device displays a pure color picture, the area of the light passing through the pixels in the first region of the color filter substrate and mixed with the pure black color is smaller, such that the picture displayed on the edge of the liquid crystal display device is consistent to the picture displayed in the middle portion, thereby avoiding the problem that the liquid crystal display device has different display effects at the edge and the middle portion, so that the liquid crystal display device displays the same picture.

According to the above embodiment, it can be known:

The embodiment of the present invention provides a color filter substrate, the color filter substrate includes a non-display area and a display area, in a pixel arrangement direction, the display area includes a first region in contact with the non-display area, and a second region not in contact with the non-display area, and opening ratios of pixels in the first region are smaller than opening ratios of pixels in the second region. By reducing the opening ratio of the pixels in the first region near the non-display area, the area of the lights of the pixels in the first region and mixed with the pure black is smaller, so that the display area exhibits the same color mixing effect. Further, by reducing the opening ratios of the pixels on both sides of the display area, the same color mixing effect can be exhibited in different areas of the display area for different pictures. Further, by setting a third region between the first region and the second region, and setting opening ratios of the pixels in the third region to be larger than the opening ratios of the pixels in the first region, and the opening ratios of the pixels of the third region to be smaller than the opening ratios of the pixels in the second region, so that when displayed, the third region will take a buffering effect, making the color mixing effect of different areas of the display area more consistent. By setting the opening ratio of each column of sub-pixels in each column to be equal, when the two or more columns of pixels are detected, the uneven brightness of the display does not occur. Further, by disposing the color filter substrate on the display device, the display device presents a consistent picture when displaying the screen, thereby improving the picture effect.

In the above, although the present invention has been disclosed in the above preferred embodiments, the preferred embodiments are not intended to limit the invention, and those skilled in the art can make various modifications without departing from the spirit and scope of the application, so the scope of this invention is subject to the scope defined by the claims.

What is claimed is:

1. A color filter substrate comprising:
a non-display area;
a display area, in a pixel arrangement direction, comprising a first region in contact with the non-display area, and a second region not in contact with the non-display area, opening ratios of pixels in the first region being smaller than opening ratios of pixels in the second region;
wherein the display area further comprises a third region between the first region and the second region, opening ratios of pixels in the third region are greater than the opening ratios of the pixels in the first region, and the opening ratios of the pixels in the third region are smaller than the opening ratios of the pixels in the second region; and
the first region comprises a column of pixels.

2. The color filter substrate as claimed in claim 1, wherein the opening ratio of each pixel in the first region is smaller than the opening ratio of each pixel in the second region.

3. The color filter substrate as claimed in claim 1, wherein the opening ratios of columns of sub-pixels of the pixels in the first region are the same.

4. The color filter substrate as claimed in claim 1, wherein the opening ratios of rows of sub-pixels of the pixels in the first region are the same.

5. The color filter substrate as claimed in claim 1, wherein in the first region the average value of the opening ratios of columns of sub-pixels of the pixels is equal to the average value of the opening ratios of rows of sub-pixels of the pixels.

6. A color filter substrate comprising:
a non-display area; and
a display area, in a pixel arrangement direction, comprising a first region in contact with the non-display area, and a second region not in contact with the non-display area, and opening ratios of pixels in the first region being smaller than opening ratios of pixels in the second region.

7. The color filter substrate as claimed in claim 6, wherein the first region comprises a left side region in contact with the non-display area and a right side region in contact with the non-display area.

8. The color filter substrate as claimed in claim 7, wherein the opening ratios of pixels in the left side region are equal to the opening ratios of pixels in the right side region.

9. The color filter substrate as claimed in claim 6, wherein the first region comprises a column of pixels.

10. The color filter substrate as claimed in claim 9, wherein the opening ratio of each pixel in the first region is smaller than the opening ratio of each pixel in the second region.

11. The color filter substrate as claimed in claim 9, wherein the opening ratios of columns of sub-pixels of the pixels in the first region are the same.

12. The color filter substrate as claimed in claim 9, wherein the opening ratios of rows of sub-pixels of the pixels in the first region are the same.

13. The color filter substrate as claimed in claim 9, wherein in the first region the average value of the opening ratios of columns of sub-pixels of the pixels is equal to the average value of the opening ratios of rows of sub-pixels of the pixels.

14. The color filter substrate as claimed in claim 6, wherein the ratio of the opening ratio of the pixels in the first region to the opening ratio of the pixels in the second region is 0.6.

15. The color filter substrate as claimed in claim 6, wherein the display area further comprises a third region between the first region and the second region, opening ratios of pixels in the third region are greater than the opening ratios of the pixels in the first region, and the opening ratios of the pixels in the third region are smaller than the opening ratios of the pixels in the second region.

16. The color filter substrate as claimed in claim 15, wherein the third region comprises a column of pixels.

17. The color filter substrate as claimed in claim 16, wherein the opening ratio of each pixel in the third region is greater than the opening ratio of each pixel in the first region, and the opening ratio of each pixel in the third region is smaller than the opening ratio of each pixel in the second region.

18. The color filter substrate as claimed in claim 16, wherein the opening ratios of columns of sub-pixels of the pixels in the third region are the same.

19. The color filter substrate as claimed in claim 16, wherein the opening ratios of rows of sub-pixels of the pixels in the third region are the same.

20. The color filter substrate as claimed in claim 16, wherein in the third region the average value of the opening ratios of columns of sub-pixels of the pixels is equal to the average value of the opening ratios of rows of sub-pixels of the pixels.
